(19) United States
(12) Patent Application Publication
(10) Pub. No.: US 2017/0235564 A1
(43) Pub. Date: Aug. 17, 2017

(54) SOFTWARE UPGRADE METHOD AND DEVICE

(71) Applicant: Huawei Technologies Co., Ltd., Shenzhen, Guangdong (CN)

(72) Inventors: Wenkang Feng, Shenzhen (CN); Kaibing Zhang, Xi'an (CN); Xinchao Shui, Xi'an (CN); Junbo Wen, Kuala Lumpur (MY)

(21) Appl. No.: 15/519,077

(22) PCT Filed: Oct. 14, 2014
(86) PCT No.: PCT/CN2014/088570

§ 371 Date: Apr. 13, 2017

(51) Int. Cl. G06F 9/445

(52) U.S. Cl. CPC G06F 8/65

(57) ABSTRACT

A software upgrade method and a device, which relate to the field of communications technologies. Software upgrade is performed for a terminal by using an access device located in a local area network, which avoids access to the Internet when software of the terminal is upgraded and reduces load or burden of a network. The method includes: receiving, by an access device, software information sent by at least one terminal device in a local area network in which the access device is located, and performing a comparison between the software information sent by the at least one terminal device and software information stored in the access device, to determine whether to-be-updated target software exists; if it is determined that to-be-updated target software exists in the at least one terminal device, transmitting update information of the target software to a terminal device corresponding to the target software.

### CROSS REFERENCE TO RELATED APPLICATIONS

The present application claims priority under 35 U.S.C. §365 to International Patent Application No. PCT/CN2014/088570 filed Oct. 14, 2014 which is incorporated herein by reference into the present disclosure as if fully set forth herein.

### TECHNICAL FIELD

The present invention relates to the field of communications technologies, and in particular, to a software upgrade method and a device.

### BACKGROUND

Due to its good mobility, a mobile terminal has been favored by an increasing quantity of people and has become an indispensable article for daily use in people's lives, and with development of communications technologies, a version of software that runs inside the mobile terminal is being continuously upgraded. To ensure that the version of the software inside the mobile terminal is a new version, the software in the mobile terminal needs to be upgraded and maintained.

Currently, online upgrade of software in a mobile terminal is generally implemented in a system architecture shown in FIG. 1. Firstly, the mobile terminal accesses, by using a mobile communications network (such as the Internet), an upgrade server that stores a software package and detects whether a new version of upgrade software exits on the upgrade server. If it is determined that a new version of upgrade software exits on the upgrade server, an upgrade software package is downloaded from the upgrade server in a manner of Hyper Text Transfer Protocol (English: Hyper Text Transfer Protocol, HTTP for short) and software upgrade is performed. It can be learned that in the prior art a mobile terminal needs to access an upgrade server through the Internet and download a new software version to implement software upgrade. In this case, if multiple mobile terminals perform software upgrade at the same time, the multiple mobile terminals access the upgrade server through the Internet at the same time, which causes heavy network workload and increases load or burden of a network.

### SUMMARY

Embodiments of the present invention provide a software upgrade method and a device to resolve a problem in the prior art that a network is overloaded when multiple mobile terminals access an upgrade server through the Internet at the same time to perform software upgrade.

To achieve the foregoing objective, the following technical solutions are adopted in the embodiments of the present invention:

According to a first aspect, an embodiment of the present invention provides a software upgrade method, where the method includes:

receiving, by an access device, software information sent by at least one terminal device in a local area network in which the access device is located;

performing, by the access device, a comparison between the software information sent by the at least one terminal device and software information stored in the access device, to determine whether to-be-updated target software exists;

if it is determined that to-be-updated target software exists in the at least one terminal device, transmitting update information of the target software to a terminal device corresponding to the target software, so that the terminal device corresponding to the target software updates the target software of the terminal device according to the update information of the target software; and

if it is determined that to-be-updated target software exists in the access device, obtaining update information of the target software of a target terminal device and updating the target software of the access device according to the update information, where the target terminal device is a terminal device that stores the update information of the target software.

With reference to the first aspect, in a first possible implementation manner of the first aspect, the software information includes: a device model and a software version.

With reference to the first possible implementation manner of the first aspect, in a second possible implementation manner of the first aspect, the performing, by the access device, a comparison between the software information sent by the at least one terminal device and software information stored in the access device, to determine whether to-be-updated target software exists includes:

performing, by the access device, a comparison between a device model in the software information sent by the terminal device and a device model in the software information stored in the access device;

if the device model in the software information is the same as the device model in the software information stored in the access device, performing a comparison between a software version in the software information of the at least one terminal device and a software version in the software information stored in the access device;

if the software version in the software information of the at least one terminal device is earlier than the software version in the software information stored in the access device, determining that to-be-updated target software exists in the at least one terminal device; and

if the software version in the software information stored in the access device is earlier than the software version in the software information of the at least one terminal device, determining that to-be-updated target software exists in the access device.

With reference to any one of the first aspect to the second possible implementation manner of the first aspect, in a third possible implementation manner of the first aspect,

the access device communicates with the terminal device by means of WiFi, a network port, Bluetooth, and infrared.

According to a second aspect, an embodiment of the present invention provides an access device, including:

a receiving unit, configured to receive software information sent by at least one terminal device in a local area network in which the access device is located;

a determining unit, configured to perform a comparison between the software information sent by the at least one terminal device and software information stored in the access device, to determine whether to-be-updated target software exists; and

a software update unit, configured to: if it is determined that to-be-updated target software exists in the at least one terminal device, transmit update information of the target software to a terminal device corresponding to the target software, so that the terminal device corresponding to the target software updates the target software of the terminal device according to the update information of the target software; and

if it is determined that to-be-updated target software exists in the access device, obtain update information of the target software of a target terminal device and update the target software of the access device according to the update information, where the target terminal device is a terminal device that stores the update information of the target software.

With reference to the second aspect, in a first possible implementation manner of the second aspect, the software information includes: a device model and a software version.

With reference to the first possible implementation manner of the second aspect, in a second possible implementation manner of the second aspect, the determining unit is specifically configured to:

perform a comparison between a device model in the software information sent by the terminal device and a device model in the software information stored in the access device;

if the device model in the software information is the same as the device model in the software information stored in the access device, perform a comparison between a software version in the software information of the at least one terminal device and a software version in the software information stored in the access device;

if the software version in the software information of the at least one terminal device is earlier than the software version in the software information stored in the access device, determine that to-be-updated target software exists in the at least one terminal device; and

if the software version in the software information stored in the access device is earlier than the software version in the software information of the at least one terminal device, determine that to-be-updated target software exists in the access device.

According to a third aspect, an embodiment of the present invention provides an access device, including:

a communications unit, configured to receive software information sent by a terminal device in a local area network in which the access device is located; and

a processor, configured to: perform a comparison between the software information sent by the at least one terminal device and software information stored in the access device, to determine whether to-be-updated target software exists;

if it is determined that to-be-updated target software exists in the at least one terminal device, transmit update information of the target software to a terminal device corresponding to the target software, so that the terminal device corresponding to the target software updates the target software of the terminal device according to the update information of the target software; and

if it is determined that to-be-updated target software exists in the access device, obtain update information of the target software of a target terminal device and update the target software of the access device according to the update information, where the target terminal device is a terminal device that stores the update information of the target software.

With reference to the third aspect, in a first possible implementation manner of the third aspect, the software information includes: a device model and a software version.

With reference to the first possible implementation manner of the third aspect, in a second possible implementation manner of the third aspect, the processor is specifically configured to:

perform a comparison between a device model in the software information sent by the terminal device and a device model in the software information stored in the access device;

if the device model in the software information is the same as the device model in the software information stored in the access device, perform a comparison between a software version in the software information of the at least one terminal device and a software version in the software information stored in the access device;

if the software version in the software information of the at least one terminal device is earlier than the software version in the software information stored in the access device, determine that to-be-updated target software exists in the at least one terminal device; and

if the software version in the software information stored in the access device is earlier than the software version in the software information of the at least one terminal device, determine that to-be-updated target software exists in the access device.

It can be learned from the foregoing description that, according to the software upgrade method and the device that are provided in the embodiments of the present invention, an access device receives software information sent by at least one terminal device in a local area network in which the access device is located, and performs a comparison between the software information sent by the at least one terminal device and software information stored in the access device, to determine whether to-be-updated target software exists; if it is determined that to-be-updated target software exists in the at least one terminal device, update information of the target software is transmitted to a terminal device corresponding to the target software, so that the terminal device corresponding to the target software updates the target software of the terminal device according to the update information of the target software; and if it is determined that to-be-updated target software exists in the access device, update information of the target software of a target terminal device is obtained and the target software of the access device is updated according to the update information, where the target terminal device is a terminal device that stores the update information of the target software. Therefore, software upgrade is performed for the terminal device by the access device that is located in the same local area network as the terminal device, so that the terminal device does not need to access an upgrade server through the Internet to implement software upgrade, which avoids access to the Internet when software of the terminal device is upgraded and reduces load or burden of a network.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is an architecture diagram of a software upgrade system in the prior art;

FIG. 2 is a flowchart of a software upgrade method according to an embodiment of the present invention;

FIG. 3 is a schematic diagram of a first human-machine interaction interface according to an embodiment of the present invention;

FIG. 4 is a schematic diagram of a second human-machine interaction interface according to an embodiment of the present invention;

FIG. 5 is a structural diagram of an access device 50 according to an embodiment of the present invention; and

FIG. 6 is a structural diagram of an access device 60 according to an embodiment of the present invention.

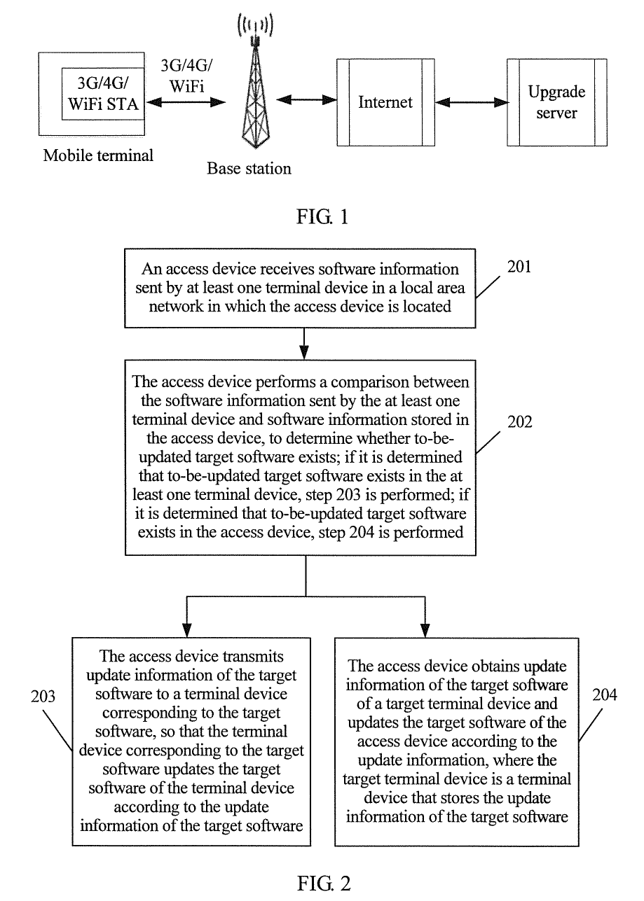

### DETAILED DESCRIPTION

With reference to the accompanying drawings in the embodiments of the present invention, the following clearly and completely describes the technical solutions in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

### Embodiment 1

FIG. 2 is a flowchart of a software upgrade method according to an embodiment of the present invention. As shown in FIG. 2, the method may include:

201. An access device receives software information sent by at least one terminal device in a local area network in which the access device is located.

The access device may be a device such as a wireless local area network (English: Wireless Fidelity, WiFi for short) hotspot, a wireless router, a smartphone, or a computer; a mobile terminal may be a device such as a smartphone or a computer.

Preferably, the access device may receive software information sent by the at least one mobile terminal by using a packet in any one of the following forms:

a Hyper Text Transfer Protocol (English: Hyper Text Transfer Protocol, HTTP for short) packet, a socket (Socket) packet, a Transmission Control Protocol (English: Transmission Control Protocol, TCP for short) packet, or a User Datagram Protocol (English: User Datagram Protocol, UDP for short) packet.

202. The access device performs a comparison between the software information sent by the at least one terminal device and software information stored in the access device, to determine whether to-be-updated target software exists; if it is determined that to-be-updated target software exists in the at least one terminal device, step 203 is performed; if it is determined that to-be-updated target software exists in the access device, step 204 is performed.

Preferably, to ensure software upgrade between devices of a same model, the software information may include: a device model and a software version.

Correspondingly, the performing a comparison between the software information sent by the at least one terminal device and software information stored in the access device, to determine whether to-be-updated target software exists may include:

performing, by the access device, a comparison between a device model in the software information sent by the terminal device and a device model in the software information stored in the access device;

if the device model in the software information is the same as the device model in the software information stored in the access device, performing a comparison between a software version in the software information of the at least one terminal device and a software version in the software information stored in the access device;

if the software version in the software information of the at least one terminal device is earlier than the software version in the software information stored in the access device, determining that to-be-updated target software exists in the at least one terminal device; and

if the software version in the software information stored in the access device is earlier than the software version in the software information of the at least one terminal device, determining that to-be-updated target software exists in the access device.

The device model may be a model of a device manufactured by a specific device manufacturer at a different stage, for example, the device model may be Huawei E5, or may be Apple iphone6S, or the like.

For example, if a device model in software information sent by a terminal device 1 is Huawei E5, and a sent software version is QQ2011, and the device model in the software information stored in the access device is E5, and the software version is QQ2014, it is determined, by means of comparison, that to-be-updated target software QQ exists in the terminal device 1. If the device model in the software information sent by the terminal device 1 is Huawei E5, and the sent software version is QQ2014, and the device model in the software information stored in the access device is E5, and the software version is QQ2013, it is determined, by means of comparison, that to-be-updated target software QQ exists in the access device.

It should be noted that the access device may store software information of multiple terminal devices. When the access device stores software information of multiple terminal devices, preferably, the foregoing method may be used to perform a comparison between the received software information sent by the at least one terminal device and multiple pieces of software information stored in the access device one by one, to determine whether to-be-updated target software exists.

203. The access device transmits update information of the target software to a terminal device corresponding to the target software, so that the terminal device corresponding to the target software updates the target software of the terminal device according to the update information of the target software.

Preferably, the transmitting update information of the target software to a terminal device corresponding to the target software, so that the terminal device corresponding to the target software updates the target software of the terminal device according to the update information of the target software may include:

sending prompt information to the at least one terminal device, where the prompt information is used to notify a user who uses the terminal device that the update information of the target software exists;

receiving a download request sent by the terminal device, where the download request is initiated by the user who uses the terminal device, and is used to request to download the update information of the target software;

obtaining the update information of the target software; and

sending the update information of the target software to the terminal device, so that the terminal device corresponding to the target software updates the target software of the terminal device according to the update information of the target software.

The access device may obtain the update information of the target software in an existing online upgrade manner, where the update information of the target software is pre-stored in the access device. Latest information of the target software may further be obtained from another terminal device in the local area network, where the another terminal device is a device that includes the update information of the target software, and the access device stores software information of target software in the another terminal device.

204. The access device obtains update information of the target software of a target terminal device and updates the target software of the access device according to the update information, where the target terminal device is a terminal device that stores the update information of the target software.

Preferably, the obtaining update information of the target software of a target terminal device may include:

displaying, by the access device, a first prompt message on a first human-machine interaction interface of the access device, where the first prompt message is used to prompt a user who uses the access device that to-be-updated target software exists;

receiving a download request that is entered by the user by using the first human-machine interaction interface;

sending the download request to the target terminal device, where the download request is used to request to download update information of the target software; and

obtaining the update information of the target software sent by the target terminal.

The access device may automatically display the first prompt message on a human-machine interaction interface of the access device, or may display the first prompt message on a human-machine interaction interface of the access device at a preset moment, which is not limited in this embodiment of the present invention.

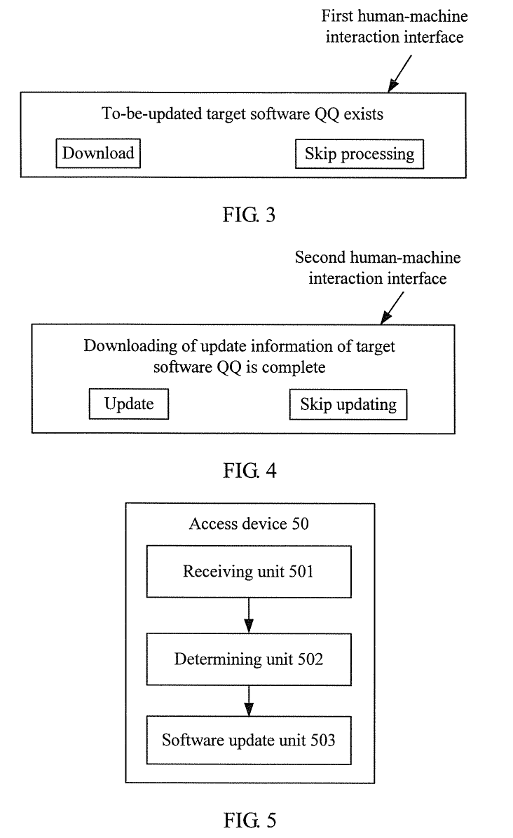

For example, in this embodiment of the present invention, the first prompt message may be displayed on a human-machine interaction interface shown in FIG. 3. After the interface displays the first prompt message, a user may tap a download button according to a personal need to send a download request, or may tap an ignore button to ignore the prompt message, that is, update information of the target software is not downloaded.

Preferably, after receiving the update information of the target software, the access device may automatically update the target software in the access device according to the update information of the target software. The target software in the access device may also be updated by using the following method:

displaying a second prompt message on a second human-machine interaction interface of the access device, where the second prompt message is used to prompt a user who uses the access device that downloading of the update information of the target software is complete;

receiving an update instruction that is entered by the user by using the second human-machine interaction interface; and

updating the target software in the access device.

For example, FIG. 4 is a schematic diagram of a second human-machine interaction interface according to an embodiment of the present invention. After the interface displays the second prompt message, a user may tap an update button according to a requirement to send an update instruction, so as to implement update and upgrade of target software, or may tap a skip updating button so that the access device automatically saves update information of the target software and performs software update at a preset moment.

Further, in this embodiment of the present invention, the access device communicates with the terminal device by means of WiFi, a network port, Bluetooth, and infrared.

It can be learned from the foregoing description that, according to the software upgrade method provided in this embodiment of the present invention, an access device receives software information sent by at least one terminal device in a local area network in which the access device is located, and performs a comparison between the software information sent by the at least one terminal device and software information stored in the access device, to determine whether to-be-updated target software exists; if it is determined that to-be-updated target software exists in the at least one terminal device, update information of the target software is transmitted to a terminal device corresponding to the target software, so that the terminal device corresponding to the target software updates the target software of the terminal device according to the update information of the target software; and if it is determined that to-be-updated target software exists in the access device, update information of the target software of a target terminal device is obtained and the target software of the access device is updated according to the update information, where the target terminal device is a terminal device that stores the update information of the target software. Therefore, software upgrade is performed for the terminal device by the access device that is located in the same local area network as the terminal device, so that the terminal device does not need to access an upgrade server through the Internet to implement software upgrade, which avoids access to the Internet when software of the terminal device is upgraded and reduces load or burden of a network.

### Embodiment 2

FIG. 5 is a structural diagram of an access device 50 according to an embodiment of the present invention. As shown in FIG. 5, the access device 50 may include:

a receiving unit 501, configured to receive software information sent by at least one terminal device in a local area network in which the access device is located;

a determining unit 502, configured to perform a comparison between the software information sent by the at least one terminal device and software information stored in the access device, to determine whether to-be-updated target software exists; and

a software update unit 503, configured to: if it is determined that to-be-updated target software exists in the at least one terminal device, transmit update information of the target software to a terminal device corresponding to the target software, so that the terminal device corresponding to the target software updates the target software of the terminal device according to the update information of the target software; and

if it is determined that to-be-updated target software exists in the access device, obtain update information of the target software of a target terminal device and update the target software of the access device according to the update information, where the target terminal device is a terminal device that stores the update information of the target software.

Further, the access unit 501 is specifically configured to receive software information sent by the at least one mobile terminal by using a packet in any one of the following forms:

an HTTP packet, a Socket packet, a TCP packet, or a UDP packet.

Further, the software information may include: a device model and a software version. The determining unit 502 is specifically configured to: perform a comparison between a device model in the software information sent by the terminal device and a device model in the software information stored in the access device;

if the device model in the software information is the same as the device model in the software information stored in the access device, perform a comparison between a software version in the software information of the at least one terminal device and a software version in the software information stored in the access device;

if the software version in the software information of the at least one terminal device is earlier than the software version in the software information stored in the access device, determine that to-be-updated target software exists in the at least one terminal device; and

if the software version in the software information stored in the access device is earlier than the software version in the software information of the at least one terminal device, determine that to-be-updated target software exists in the access device.

The device model may be a model of a device manufactured by a specific device manufacturer at a different stage, for example, the device model may be Huawei E5, or may be Apple iphone6S, or the like.

Further, when the determining unit 502 determines that to-be-updated target software exists in the at least one terminal device, the software update unit 503 is specifically configured to:

send prompt information to the at least one terminal device, where the prompt information is used to notify a user who uses the terminal device that the update information of the target software exists;

receive a download request sent by the terminal device, where the download request is initiated by the user who uses the terminal device, and is used to request to download the update information of the target software;

obtain the update information of the target software; and

send the update information of the target software to the terminal device, so that the terminal device corresponding to the target software updates the target software of the terminal device according to the update information of the target software.

Further, when the determining unit 502 determines that to-be-updated target software exists in the access device, the software update unit 503 is specifically configured to:

display a first prompt message on a first human-machine interaction interface of the access device, where the first prompt message is used to prompt a user who uses the access device that to-be-updated target software exists;

receive a download request that is entered by the user by using the first human-machine interaction interface;

send the download request to the target terminal device, where the download request is used to request to download update information of the target software; and

obtain the update information of the target software sent by the target terminal.

The software update unit 503 may automatically display the first prompt message on a human-machine interaction interface of the access device, or may display the first prompt message on a human-machine interaction interface of the access device at a preset moment, which is not limited in this embodiment of the present invention.

For example, in this embodiment of the present invention, the first prompt message may be displayed on a human-machine interaction interface shown in FIG. 3. After the interface displays the first prompt message, a user may tap a download button according to a personal need to send a download request, or may tap an ignore button to ignore the prompt message, that is, update information of the target software is not downloaded.

Further, after the software update unit 503 obtains the update information of the target software, the software update unit 503 may be configured to automatically update the target software in the access device according to the update information of the target software, and may be further configured to:

display a second prompt message on a second human-machine interaction interface of the access device, where the second prompt message is used to prompt a user who uses the access device that downloading of the update information of the target software is complete;

receive an update instruction that is entered by the user by using the second human-machine interaction interface; and

update the target software in the access device.

For example, FIG. 4 is a schematic diagram of a second human-machine interaction interface according to an embodiment of the present invention. After the interface displays the second prompt message, a user may tap an update button according to a requirement to send an update instruction, so as to implement update and upgrade of target software, or may tap a skip updating button so that the access device automatically saves update information of the target software and performs software update at a preset moment.

It can be learned from the foregoing description that, the access device 50 provided in this embodiment of the present invention receives software information sent by at least one terminal device in a local area network in which the access device is located, and performs a comparison between the software information sent by the at least one terminal device and software information stored in the access device, to determine whether to-be-updated target software exists; if it is determined that to-be-updated target software exists in the at least one terminal device, update information of the target software is transmitted to a terminal device corresponding to the target software, so that the terminal device corresponding to the target software updates the target software of the terminal device according to the update information of the target software; and if it is determined that to-be-updated target software exists in the access device, update information of the target software of a target terminal device is obtained and the target software of the access device is updated according to the update information, where the target terminal device is a terminal device that stores the update information of the target software. Therefore, software upgrade is performed for the terminal device by the access device that is located in the same local area network as the terminal device, so that the terminal device does not need to access an upgrade server through the Internet to implement software upgrade, which avoids access to the Internet when software of the terminal device is upgraded and reduces load or burden of a network.

### Embodiment 3

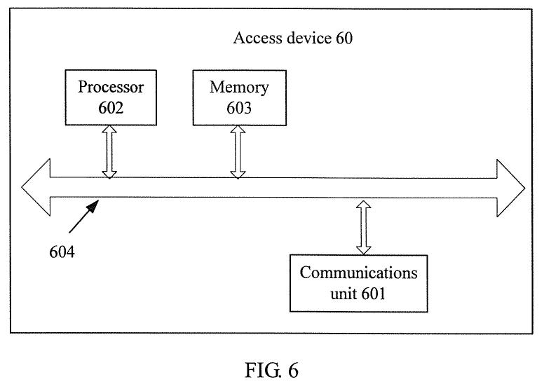

FIG. 6 is a structural diagram of a receiving device 60 according to an embodiment of the present invention. As shown in FIG. 6, the access device 60 may include: a communications unit 601, a processor 602, a memory 603, and at least one communications bus 604, configured to implement connection and mutual communication between the apparatuses.

The communications unit 601 is configured to perform data transmission with external network elements.

The processor 602 may be a central processing unit (English: central processing unit, CPU for short).

The memory 603 may be a volatile memory (English: volatile memory) such as a random-access memory (English: random-access memory, RAM for short) or a non-volatile memory (English: non-volatile memory) such as a read-only memory (English: read-only memory, ROM for short), a flash memory (English: flash memory), a hard disk drive (English: hard disk drive, HDD for short), or a solid-state drive (English: solid-state drive, SSD for short), or a combination of the foregoing types of memories. The memory 603 is configured to provide an instruction and data including software information to the processor 602.

The communications unit 601 is configured to receive software information sent by at least one terminal device in a local area network in which the access device is located.

The processor 602 is configured to: perform a comparison between the software information sent by the at least one terminal device and software information stored in the access device, to determine whether to-be-updated target software exists;

if it is determined that to-be-updated target software exists in the at least one terminal device, transmit update information of the target software to a terminal device corresponding to the target software, so that the terminal device corresponding to the target software updates the target software of the terminal device according to the update information of the target software; and

if it is determined that to-be-updated target software exists in the access device, obtain update information of the target software of a target terminal device and update the target software of the access device according to the update information, where the target terminal device is a terminal device that stores the update information of the target software.

Further, the communications unit 601 is specifically configured to receive software information sent by the at least one mobile terminal by using a packet in any one of the following forms:

an HTTP packet, a Socket packet, a TCP packet, or a UDP packet.

Further, the software information may include: a device model and a software version. The processor 602 is specifically configured to: perform a comparison between a device model in the software information sent by the terminal device and a device model in the software information stored in the access device;

if the device model in the software information is the same as the device model in the software information stored in the access device, perform a comparison between a software version in the software information of the at least one terminal device and a software version in the software information stored in the access device;

if the software version in the software information of the at least one terminal device is earlier than the software version in the software information stored in the access device, determine that to-be-updated target software exists in the at least one terminal device; and

if the software version in the software information stored in the access device is earlier than the software version in the software information of the at least one terminal device, determine that to-be-updated target software exists in the access device.

The device model may be a model of a device manufactured by a specific device manufacturer at a different stage, for example, the device model may be Huawei E5, or may be Apple iphone6S, or the like.

Further, when the processor 602 determines that to-be-updated target software exists in the at least one terminal device, the processor 602 is specifically configured to:

send prompt information to the at least one terminal device, where the prompt information is used to notify a user who uses the terminal device that the update information of the target software exists;

receive a download request sent by the terminal device, where the download request is initiated by the user who uses the terminal device, and is used to request to download the update information of the target software;

obtain the update information of the target software; and

send the update information of the target software to the terminal device, so that the terminal device corresponding to the target software updates the target software of the terminal device according to the update information of the target software.

Further, when the processor 602 determines that to-be-updated target software exists in the access device, the processor 602 is specifically configured to:

display a first prompt message on a first human-machine interaction interface of the access device, where the first prompt message is used to prompt a user who uses the access device that to-be-updated target software exists;

receive a download request that is entered by the user by using the first human-machine interaction interface;

send the download request to the target terminal device, where the download request is used to request to download update information of the target software; and

obtain the update information of the target software sent by the target terminal.

The processor 602 may automatically display the first prompt message on a human-machine interaction interface of the access device, or may display the first prompt message on a human-machine interaction interface of the access device at a preset moment, which is not limited in this embodiment of the present invention.

For example, in this embodiment of the present invention, the first prompt message may be displayed on a human-machine interaction interface shown in FIG. 3. After the interface displays the first prompt message, a user may tap a download button according to a personal need to send a download request, or may tap an ignore button to ignore the prompt message, that is, update information of the target software is not downloaded.

Further, after the processor 602 obtains the update information of the target software, the processor 602 may be configured to automatically update the target software in the access device according to the update information of the target software, and may be further configured to:

display a second prompt message on a second human-machine interaction interface of the access device, where the second prompt message is used to prompt a user who uses the access device that downloading of the update information of the target software is complete;

receive an update instruction that is entered by the user by using the second human-machine interaction interface; and

update the target software in the access device.

For example, FIG. 4 is a schematic diagram of a second human-machine interaction interface according to an embodiment of the present invention. After the interface displays the second prompt message, a user may tap an update button according to a requirement to send an update instruction, so as to implement update and upgrade of target software, or may tap a skip updating button so that the access device automatically saves update information of the target software and performs software update at a preset moment.

It can be learned from the foregoing description that, the access device 60 provided in this embodiment of the present invention receives software information sent by at least one terminal device in a local area network in which the access device is located, and performs a comparison between the software information sent by the at least one terminal device and software information stored in the access device, to determine whether to-be-updated target software exists; if it is determined that to-be-updated target software exists in the at least one terminal device, update information of the target software is transmitted to a terminal device corresponding to the target software, so that the terminal device corresponding to the target software updates the target software of the terminal device according to the update information of the target software; and if it is determined that to-be-updated target software exists in the access device, update information of the target software of a target terminal device is obtained and the target software of the access device is updated according to the update information, where the target terminal device is a terminal device that stores the update information of the target software. Therefore, software upgrade is performed for the terminal device by the access device that is located in the same local area network as the terminal device, so that the terminal device does not need to access an upgrade server through the Internet to implement software upgrade, which avoids access to the Internet when software of the terminal device is upgraded and reduces load or burden of a network.

In the several embodiments provided in the present application, it should be understood that the disclosed system, mobile terminal, and method may be implemented in other manners. For example, the described mobile terminal embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections of the mobile terminal or a unit may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a USB flash drive, a removable hard disk, a read-only memory (Read-Only Memory, ROM for short), a random access memory (Random Access Memory, RAM for short), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1-18. (canceled)

19. A software upgrade method, comprising:
receiving, by an access device, software information sent by at least one terminal device in a local area network in which the access device is located;
performing, by the access device, a comparison between the software information sent by the at least one terminal device and software information stored in the access device, to determine whether to-be-updated target software exists;
if it is determined that to-be-updated target software exists in the at least one terminal device, transmitting update information of the target software to the at least one terminal device corresponding to the target software, so that the terminal device corresponding to the target software updates the target software of the terminal device according to the update information of the target software; and
if it is determined that to-be-updated target software exists in the access device, obtaining update information of the target software of a target terminal device and updating the target software of the access device according to the update information, wherein the target terminal device is a terminal device that stores the update information of the target software.

20. The software upgrade method according to claim 19, wherein the software information comprises: a device model and a software version.

21. The software upgrade method according to claim 20, wherein performing, by the access device, a comparison between the software information sent by the at least one terminal device and software information stored in the access device, to determine whether to-be-updated target software exists comprises:
performing, by the access device, a comparison between a device model in the software information sent by the terminal device and a device model in the software information stored in the access device;
if the device model in the software information is the same as the device model in the software information stored in the access device, performing a comparison between a software version in the software information of the at least one terminal device and a software version in the software information stored in the access device;
if the software version in the software information of the at least one terminal device is earlier than the software version in the software information stored in the access device, determining that to-be-updated target software exists in the at least one terminal device; and
if the software version in the software information stored in the access device is earlier than the software version in the software information of the at least one terminal device, determining that to-be-updated target software exists in the access device.

22. The software upgrade method according to claim 19, wherein:
the access device communicates with the terminal device by at least one means of WiFi, a network port, Bluetooth, and infrared.

23. The software upgrade method according to claim 20, wherein:
the access device communicates with the terminal device by at least one means of WiFi, a network port, Bluetooth, and infrared.

24. The software upgrade method according to claim 21, wherein:
the access device communicates with the terminal device by at least one means of WiFi, a network port, Bluetooth, and infrared.

25. An access device, comprising:
a communications unit, configured to receive software information sent by a terminal device in a local area network in which the access device is located; and
a processor, configured to: perform a comparison between the software information sent by the at least one terminal device and software information stored in the access device, to determine whether to-be-updated target software exists;
if it is determined that to-be-updated target software exists in the at least one terminal device, transmit update information of the target software to the at least one terminal device corresponding to the target software, so that the terminal device corresponding to the target software updates the target software of the terminal device according to the update information of the target software; and
if it is determined that to-be-updated target software exists in the access device, obtain update information of the target software of a target terminal device and update the target software of the access device according to the update information, wherein the target terminal device is a terminal device that stores the update information of the target software.

26. The access device according to claim 25, wherein the software information comprises: a device model and a software version.

27. The access device according to claim 26, wherein the processor is configured to:
perform a comparison between a device model in the software information sent by the terminal device and a device model in the software information stored in the access device;
if the device model in the software information is the same as the device model in the software information stored in the access device, perform a comparison between a software version in the software information of the at least one terminal device and a software version in the software information stored in the access device;
if the software version in the software information of the at least one terminal device is earlier than the software version in the software information stored in the access device, determine that to-be-updated target software exists in the at least one terminal device; and
if the software version in the software information stored in the access device is earlier than the software version in the software information of the at least one terminal device, determine that to-be-updated target software exists in the access device.
